(19) United States
(12) Patent Application Publication
(10) Pub. No.: US 2021/0357358 A1
(43) Pub. Date: Nov. 18, 2021

(54) FILE STORAGE SYSTEM AND METHOD

(71) Applicant: SHENZHEN DAPU MICROELECTRONICS CO., LTD., Shenzhen (CN)

(72) Inventor: Weijun LI, Shenzhen (CN)

(73) Assignee: SHENZHEN DAPU MICROELECTRONICS CO., LTD., Shenzhen (CN)

(21) Appl. No.: 17/388,583

(22) Filed: Jul. 29, 2021

Related U.S. Application Data
(63) Continuation of application No. PCT/CN2020/075934, filed on Feb. 20, 2020.

(30) Foreign Application Priority Data
Feb. 20, 2019 (CN) 201910124842.0

(51) Int. Cl. G06F 16/11; G06F 16/13; G06F 16/16

(52) U.S. Cl. CPC G06F 16/116; G06F 16/162; G06F 16/13

(57) ABSTRACT

A file storage system, including a host and a storage device connected to the host. The host receives a file sent by an upload terminal, and transmits the file to the storage device; and the storage device includes a format conversion module and a storage module, the format conversion module converting an initial format of the file into a target format, and the storage module storing the file of the target format. Further provided in the present disclosure is a file storage method. The file storage system and method provided in the present disclosure achieve format file conversion and storage in a storage device, so that the file format conversion does not occupy resources of a host; and avoid the need for transmitting the converted files of the target format to the storage device from the host, thereby save bus energy between the host and the storage device.

### CROSS-REFERENCE TO RELATED APPLICATIONS

The present application is a continuation of International Application No. PCT/CN2020/075934, filed on Feb. 20, 2020, which claims priority to Chinese Patent Application No. 201910124842.0, filed on Feb. 20, 2019. The entire contents of both applications are incorporated herein by reference.

### TECHNICAL FIELD

The present disclosure relates to the field of file storage technology, and in particular to file storage system and method.

### BACKGROUND

With the continuous development of Internet technology, terminal applications such as mobile phones, computers, PAD (tablet computers), and digital cameras are becoming more and more popular. Users will upload electronic pictures, knowledge documents (such as Word and PDF documents), audio and video files in their terminals through the network platform for other friends or users to share (i.e. browse or download).

In some applications, users upload electronic pictures, knowledge documents, audio, video and other files to network platforms through uploading terminals (such as WeChat Moments, Qzone, Xiaomu Chong Forum, Himalayas, Watermelon Video, Douyin, etc.). The host of the corresponding network platform server converts a variety of formats, then saves to the server storage. When visitors have to browse or download, the server host receives the request instruction, retrieves files in the format required by the visitors from storage and sends them to the accessing terminal of the accessing visitors.

However, the file format conversion in the server host will occupy the resources of the server's host. In addition, the converted files of multiple formats or sizes need to be transferred from the host to the storage via the bus, which will greatly consume the bus energy between the host and memory.

In view of this, it is necessary to provide a file storage system and method to overcome the above shortcomings.

### SUMMARY OF THE DISCLOSURE

In order to solve the above problems, the present disclosure provides a file storage system and a method that can realize file format conversion and store in a storage device, avoiding file format conversion occupying host resources, and also avoiding that files in the target format after conversion need to be transferred from the host to the storage device, saving the bus energy between the host and the storage device.

In order to achieve the above objects, the present disclosure provides a file storage system, including a host and a storage device connected to the host. The host receives a file sent by an upload terminal and transfers the file to the storage device; the storage device includes a format conversion module and a storage module; the format conversion module converts the initial format of the file into a target format, and the storage module stores the file in the target format.

In some embodiments, the storage device is a solid state drive. The storage module includes a storage controller and a plurality of storage units connected to the storage controller; and the storage controller controls the reading and writing of the plurality of storage units.

In some embodiments, the storage device further includes a processor, and the processor is in communication connection with the format conversion module and the storage controller; the processor reads and analyzes the instruction signal received by the storage device; the processor also determines whether the initial format of the file is consistent with the target format, and when the initial format of the file is inconsistent with the target format, the processor controls the format conversion module to convert the initial format of the file into the target format.

In some embodiments, the storage device further includes a bus interface, the bus interface is communicatively connected with the processor and the format conversion module; the bus interface connects to the host and transmits the instruction signal.

The present disclosure also provides a file storage method, including the following steps: receiving, by the host, the file sent by the upload terminal; transmitting, by the host, the file to the storage device; converting the initial format of the file into a target format by the format conversion module in the storage device; the storage module in the storage device stores the file in the target format.

In some embodiments, the step of converting the initial format of the file into a target format by the format conversion module in the storage device further includes the following steps: the processor in the storage device determines whether the initial format of the file is consistent with the target format, and when the initial format of the file is inconsistent with the target format; the processor controls the format conversion module to convert the initial format of the file into a target format.

In some embodiments, the step of converting the initial format of the file into the target format by the format conversion module in the storage device further includes the following steps: reading, by the processor, the upload instruction received by the storage device and analyzing, by the processor, the deadline setting information corresponding to the upload instruction; sending, by the processor, a delete instruction to the storage controller in the storage module when the storage time of the file in the storage module reaches the access period set by the user; and receiving, by the storage controller, the delete instruction and deleting the files of the storage unit in the storage module.

In some embodiments, after the step of the storage module in the storage device stores the file in the target format, the method further includes the following steps: receiving, by the host, access instruction sent by an access terminal and sending the access instruction to the storage device; calling up, by the storage device according to the access instruction, a file in the target format matching the type of the access terminal from the storage module and sending the file in the target format to the host; and sending, by the host, the target format file to the access terminal.

In some embodiments, the step of calling up, by the storage device according to the access instruction, a file in the target format matching the type of the access terminal from the storage module and sending the file in the target format to the host, further includes the following steps: converting, by the format conversion module, the format of the file requested to be accessed by the access terminal into a target format to match the type of the access terminal when the storage module does not store a file in a target format that matches the type of the access terminal, and then sending the target format file to the host.

In some embodiments, the step of sending, by the host, the target format file to the access terminal further includes the following steps: sending, by the host, an abbreviated file corresponding to the target format file to the access terminal; displaying the abbreviated files sequentially by the access terminal; transmitting, by the access terminal, a click instruction to the host when the access terminal receives the click instruction of the access user; sending, by the host, the target format file corresponding to the abbreviated file to the access terminal according to the click instruction; displaying the target format file by the access terminal.

Compared with conventional implementations, the file storage system and the method provided by the present disclosure realize the file format conversion and storage in the storage device. The file format conversion does not occupy the host resources and avoids that the converted file in the target format needs to be transferred from the host to the storage device, which saves bus energy between the host and the storage device.

In order to make the above-mentioned objects, features and advantages of the disclosure more obvious and understandable, the following is a detailed description of embodiments of the disclosure and accompanying drawings.

### BRIEF DESCRIPTION OF THE DRAWINGS

In order to more clearly illustrate the technical scheme of embodiments of the disclosure, a brief description of the drawings required in the embodiments is given below. It is to be understood that the following appended drawings show only certain embodiments of the present disclosure and, therefore, should not be regarded as a limitation of scope. For ordinary technicians in this field, other related drawings can be obtained according to these drawings without any creative effort.

FIG. 1 is a schematic block diagram of a file storage system provided by an embodiment of the present disclosure;

FIG. 2 is a flowchart of a file storage method provided by an embodiment of the present disclosure.

### DETAILED DESCRIPTION

The technical solutions in the embodiments of the present disclosure are clearly and completely described in the following with reference to the accompanying drawings in the embodiments of the present disclosure. It is obvious that the described embodiments are only a part of the embodiments of the present disclosure, but not all embodiments. All other embodiments obtained by a person skilled in the art based on the embodiments of the present disclosure without creative efforts are within the scope of the present disclosure.

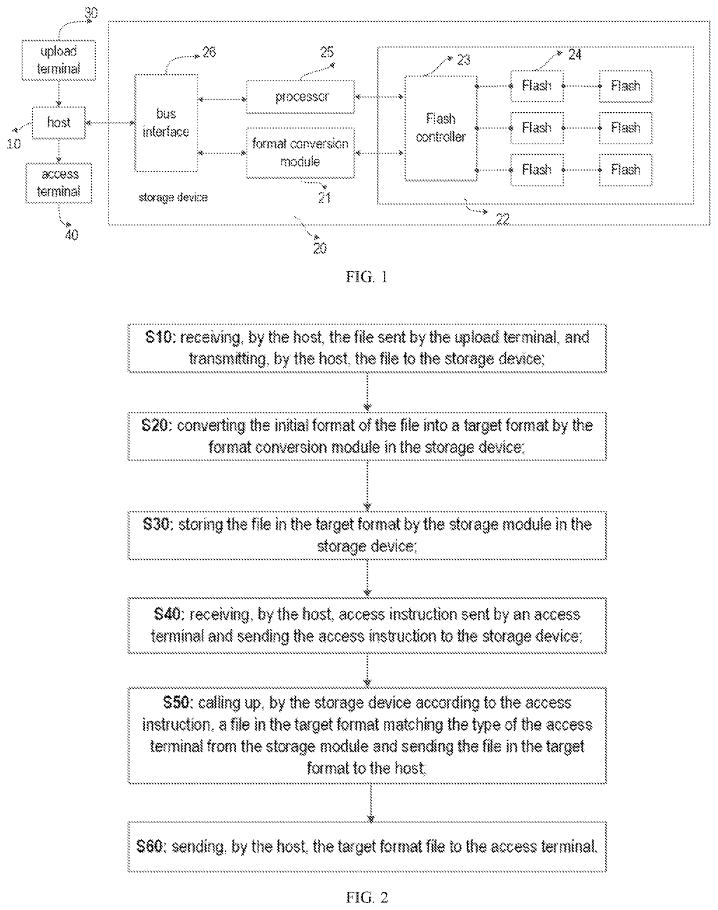

Please refer to FIG. 1, which is a schematic block diagram of a file storage system 100 according to a preferred embodiment of the present disclosure. The file storage system 100 provided by the preferred embodiment of the present disclosure includes a host 10 and a storage device 20 connected to the host 10.

The host 10 is used to receive the file sent by the upload terminal 30 and transfer the file to the storage device 20; the storage device 20 includes a format conversion module 21 and a storage module 22; the format conversion module 21 is used to convert the initial format of the file into a target format, and the storage module 22 is used to store the file in the target format.

It can be understood that the host 10 can connect to the Internet and the host 10 is a computer that can communicate information with multiple upload terminals 30 through the Internet. The upload terminal 30 can be one or more of mobile terminals of a mobile phone, a computer, a pad (tablet computer), a digital camera, etc. The files sent by the upload terminal 30 are one or more combinations of picture files, document files, audio files, and video files.

Correspondingly, the format conversion module 21 is a picture format converter, a document format converter, an audio format converter, and one or more combinations of video format converters.

The format conversion module 21 can convert the initial format of the file into a target format. Specifically, the target format is a file format common to various current terminals or a file format corresponding to a specific terminal set by the user. For example, for picture files, the target format includes jpg, jpeg, png, GIF, BMP, WEBP, HEIF, etc.; for document files, the target format includes doc, pdf, etc.; for audio files, the target format includes 3gp, mp4, m4a, Ts, 3gp, flac, mp3, way and other formats: for video files, target formats include 3gp, mp4, ts, webm, mkv, m4v, mov and other formats. The initial format can be one of the target formats or different from the target format. For example, for image files, the initial format is jpg, and the target format needs to be converted to jpeg when storing; or the initial format is tif, and the target format needs to be converted to jpeg when storing. Similar to audio files and video files, the initial format of audio files and video files can be one of the target formats or different from the target format.

In the file storage system 100 provided by an embodiment of the present disclosure, the storage device 20 includes a format conversion module 21 and a storage module 22. In the storage device 20, the format conversion module 21 converts an initial format of a file into a target format, and stores the file in the target format in the local storage module 22 of the storage device 20; that realizes the format conversion and storage of the file in the storage device 20, and the file format conversion does not occupy the resources of the host 10. In addition, it is avoided that the converted file in the target format needs to be transferred from the host 10 to the storage device 20, so the bus energy between the host 10 and the storage device 20 is saved. In this embodiment, the storage device 20 is a solid state drive, that is, the solid state drive includes a format conversion module 21 and a storage module 22, and the solid state drive can realize file format conversion and storage.

The storage module 22 includes a storage controller (i.e. Flash controller) 23 and multiple storage units (i.e. Flash) 24 that connected to the storage controller 23. The storage controller 23 is used to control reading and writing of the multiple storage units 24. Specifically, the storage controller 23 has a control chip to realize functions such as reading and writing, wear leveling, and life monitoring of the storage unit.

The storage device 20 also includes a processor 25, which is in communication connection with the format conversion module 21 and the storage controller 23, and the processor 25 is used to read the instruction signal received by the storage device 20; specifically, the processor 25 generates the corresponding operation control signal of the the instruction signal after reading the instruction signal received by the storage device 20, and sends the corresponding operation control signal to the format conversion module 21 and the storage controller 23, so as to control the format conversion module 21 and storage controller 23 to perform actions according to the requirements of the instruction signal. The processor 25 is also used to determine whether the initial format of the file is consistent with the target format. The instruction signal may be an upload instruction (that is, an instruction signal corresponding to the upload terminal 30 requesting an upload file) or an access instruction (that is, an instruction signal corresponding to the access terminal 40 requesting access to the uploaded file), and the operation control signal may be a storage instruction, a conversion instruction or a delete instruction.

For example, the upload terminal 30 sends an upload instruction to the host 10, and the host 10 receives the upload instruction and transmits the upload instruction to the storage device 20, and then the processor 25 reads the upload instruction and determines whether the original format of the uploaded file is consistent with the target format. If the initial format of the uploaded file is consistent with the target format, the processor 25 sends a storage instruction to the storage module 22, and the storage controller 23 in the storage module 22 receives the storage instruction and stores the uploaded file in the storage unit 24; on the contrary, if the initial format of the uploaded file is inconsistent with the target format, the processor 25 sends a conversion instruction to the format conversion module 21, and the format conversion module 21 receives the conversion instruction and converts the initial format of the uploaded file to the target format, and then sends the storage instruction to the storage module 22. The storage controller 23 in the storage module 22 receives the storage instruction, and stores the converted target format file in the storage unit 24.

Further, the upload instruction may include time limit setting information. After the upload terminal 30 uploads the file (that is, the uploaded file is stored in the storage unit 24), the upload terminal 30 responds to the user's time limit setting operation as setting an access period for the uploaded file. The processor 25 reads the upload instruction and analyzes the time limit setting information corresponding to the upload instruction. When the storage time of the file in the storage unit 24 reaches the access time limit set by the user, the processor 25 sends a delete instruction to the storage controller 23, and the storage controller 23 receives the delete instruction and deletes the files in the storage unit 24. The time limit setting information can be visible for three days, six months or one year. That is, when the user who uploads the file sets the access period for the uploaded file, the uploaded file is visible within the access period. When the storage time of the uploaded file reaches or exceeds the access period, the uploaded file has been deleted and is invisible, so that can save the storage space of the storage unit 24.

Further, the upload instruction may also include permission setting information. When the upload terminal 30 requests to upload a file, the upload terminal 30 responds to the user's permission setting operation to set the access permission for the uploaded file. Specifically, the permission setting information can be visible only to oneself, all visible or partially visible. The processor 25 reads the upload instruction and analyzes the permission setting information corresponding to the upload instruction. If the permission setting information is only visible to oneself, the processor 25 directly sends the storage instruction to the storage module 22, and the storage controller 23 in the storage module 22 receives the storage instruction and stores the uploaded file in the storage unit 24; if the permission setting information is all visible, the processor 25 sends a conversion instruction to the format conversion module 21, and the format conversion module 21 receives the conversion instruction and convert the initial format of the uploaded file to the target format, and then send the storage instruction to the storage module 22. The storage controller 23 in the storage module 22 receives the storage instruction and stores the converted file in the target format in the storage unit 24. At this time, the target format is the common file format of various terminals at present; if the permission setting information is partially visible, the processor 25 sends a conversion instruction to the format conversion module 21, and the format conversion module 21 receives the conversion instruction and converts the initial format of the uploaded file into the target format, then sends the storage instruction to the storage module 22. The storage controller 23 in the storage module 22 receives the storage instruction and stores the converted target format file in the storage unit 24. At this time, the target format is the file format corresponding to the type of the partially visible terminal set by the user; it can be understood that the type of the partially visible terminal set by the user can be determined according to the historical usage data of the uploaded terminal 30.

The storage device 20 also includes a bus interface 26, which is communication connected with the processor 25 and the format conversion module 21; the bus interface 26 is used to connect to the host 10 and transmit instruction signals. For example, the upload terminal 30 sends the upload instruction corresponding to the uploaded file to the host 10, the host 10 receives the upload instruction, and the host 10 transmits the upload instruction to the storage device 20 through the bus interface 26; or, when the accessing user needs to access the file of the storage system 100, the access terminal sends an access instruction to the host 10, the host 10 receives the access instruction, and the host 10 transmits the access instruction to the storage device 20 through the bus interface 26, and the storage device 20 calls up the file in the target format that matches the type of the access terminal from the storage module 22 according to the access instruction, and the target format file is sent to the host 10 through the bus interface 26. In this way, the bus interface 26 realizes the signal transmission of the upload command and the access command between the storage device 20 and the host 10.

The file storage system 100 provided by an embodiment of the present disclosure specifically includes the following. When an access user needs to access a file in the file storage system 100, the host 10 receives the access instruction request sent by the access terminal 40 and sends the access instruction to the storage device 20; the storage device 20 calls up the file in the target format that matches the type of the access terminal 40 from the storage module 22 according to the access instruction, and sends the target format file to the host 10; the host 10 sends the target format file to the access terminal 40. In this way, the file sharing between uploading terminal 30 and accessing terminal 40 is realized through file storage system 100. In addition, the file storage system 100 carries out file format conversion and storage in the storage device 20, and can directly feed back the target format file matched with the access terminal. The access terminal 40 can be one or more of mobile terminals such as mobile phone, computer, PAD (tablet computer), digital camera, etc.

Specifically, when the storage module 22 does not store a file in the target format that can match the type of the access terminal 40, the format conversion module 21 converts the format of the file requested by the access terminal 40 into a file in the target format to match the type of the access terminal 40, and send the file in the target format to the host 10. In this embodiment, if the storage module 22 does not store a file in the target format that can match the type of the access terminal 40, that is, the file format that matches the access terminal 40 is a non-universal format file, and the storage device 20 performs format conversion on the file but do not store. That is, there are no non-universal format files stored in the storage module 22, so as to reduce the space occupation of the storage module 22. In other embodiments, the converted non-universal format files can also be stored in the storage module 22, in order to directly call out the file of the target format according to the subsequent request access instruction of the access users, reducing the resource utilization of the processor 25 of the storage device 20.

The file storage system 100 provided by an embodiment of the present disclosure includes the following. When the accessing user browses the files on the access terminal 40, the first step is to browse the files in order. At this time, the host 10 only reports the abbreviated files of which the space occupation is small, that is, the host 10 sends the abbreviated files corresponding to the target format files to the access terminal 40, and the access terminal 40 displays the abbreviated files sequentially. And when the accessing user is interested in a certain file and clicks on the interested file, the host 10 feedbacks a larger but clearer file, that is, when the access terminal 40 receives a click instruction from the accessing user, the access terminal 40 transmits the click instruction to the host 10, and the host 10 transmits the target format file corresponding to the abbreviated file according to the click instruction to the access terminal 40, and the access terminal 40 displays the target format file. In this way, the resource occupation of the access terminal 40 can be greatly saved.

The file storage system 100 provided by the preferred embodiment of the present disclosure includes the following. In the storage device 20, the format conversion module 21 converts the initial format of the file into the target format, and stores the file in the target format in the storage module 22 of the storage device 20. And the format conversion and storage of files are realized in the storage device 20. The file format conversion does not occupy the resources of the host 10, and it avoids that the converted target format files need to be transferred from the host 10 to the storage device 20, so that saves bus energy between the host 10 and the storage device 20.

FIG. 2 is a flowchart of a file storage method provided by an embodiment of the present disclosure, it should be noted that the method of the present disclosure is not limited to the order of the following steps, and other embodiment. The method of the present disclosure may include only a part of the following steps, or one of the steps may be split into several steps, or multiple steps may be combined into one step. The file storage method provided by the preferred embodiment of the present disclosure includes the following steps:

Step S10: receiving, by the host, the file sent by the upload terminal:

Step S20: transmitting, by the host, the file to the storage device;

Step S30: converting the initial format of the file into a target format by the format conversion module in the storage device; the storage module in the storage device stores the file in the target format.

The file storage method provided by the embodiment of the present disclosure realizes file format conversion and storage in the storage device 20, and the file format conversion does not occupy the resources of the host 10, and avoids that the converted file in the target format needs to be transferred from the host to the storage device, which can save bus energy between the host and the storage device.

For the specific description of the file storage method in this embodiment, reference may be made to the description of the file storage system 100 in the above embodiment, which will not be repeated here.

The file storage method provided by the embodiment of the present disclosure includes the following. In step S20, the processor in the storage device determines whether the initial format of the uploaded file is consistent with the target format. If the initial format of the uploaded file is consistent with the target format, the processor 25 sends a storage instruction to the storage module 22, and the storage controller 23 in the storage module 22 receives the storage instruction and stores the uploaded file in the storage unit 24. On the contrary, if the initial format of the uploaded file is inconsistent with the target format, the processor 25 sends a conversion instruction to the format conversion module 21, and the format conversion module 21 receives the conversion instruction and converts the initial format of the uploaded file to the target format, and then sends the storage instruction to the storage module 22.

In other embodiments, in order to save the storage space of the storage module, the step of S20 further includes the following steps: reading, by the processor, the upload instruction received by the storage device and analyzing, by the processor, the deadline setting information corresponding to the upload instruction; sending, by the processor, a delete instruction to the storage controller in the storage module when the storage time of the file in the storage module reaches the access period set by the user; and receiving, by the storage controller, the delete instruction and deleting the files of the storage unit in the storage module.

In the file storage method provided by the present disclosure, when the accessing user needs to access the file in the file storage system 100, the file storage system 100 sends the file to the access terminal to realize file sharing, that is, after step S30, the method further includes the following steps:

Step S40: receiving, by the host, access instruction sent by an access terminal and sending the access instruction to the storage device:

Step S50: calling up, by the storage device according to the access instruction, a file in the target format matching the type of the access terminal from the storage module and sending the file in the target format to the host;

Step S60: sending, by the host, the target format file to the access terminal.

Specifically, in step S50, converting, by the format conversion module, the format of the file that requested to be accessed by the access terminal into a target format to match the type of the access terminal when the storage module does not store a file in a target format that matches the type of the access terminal, and then sending the target format file to the host, and then sending the target format file to the host. In this embodiment, if the storage module does not store a file in the target format that can match the type of the access terminal, that is, the file format that matches the access terminal is a non-universal format file, and the storage device performs format conversion on the file but does not store. That is, there are no non-universal format files stored in the storage module, so as to reduce the space occupation of the storage module. In other embodiments, the converted non-universal format files can also be stored in the storage module. In order to directly call out the file of the target format according to the subsequent request access instruction of the access users, the method includes reducing the resource utilization of the processor of the storage device.

The file storage method provided by the present disclosure, specifically, in step S60, further includes the following steps: sending, by the host, the abbreviated file corresponding to the target format file to the access terminal; displaying the abbreviated files sequentially by the access terminal; transmitting, by the access terminal, a click instruction to the host when the access terminal receives the click instruction of the access user; sending, by the host, the target format file corresponding to the abbreviated file to the access terminal according to the click instruction; and displaying the target format file by the access terminal.

In the above mentioned step of the S60, when the accessing user browses the files on the access terminal, the first step is to browse the files in order. At this time, the host 10 only reports the abbreviated files of which the space occupation is small. And when the accessing user is interested in a certain file and clicks on the interested file, then the host 10 feedbacks a larger but clearer file. In this way, the resource occupation of the access terminal 40 can be greatly saved.

The file storage system and the method provided by the present disclosure realize the file format conversion and storage in the storage device. The file format conversion does not occupy the host resources and avoids that the converted file in the target format needs to be transferred from the host to the storage device, which saves bus energy between the host and the storage device.

The above embodiments are only used to illustrate the technical solutions of the present disclosure, and are not intended to be limiting, although the present disclosure has been described in detail with reference to the foregoing embodiments, those of ordinary skill in the art should understand that the technical solutions are described as being modified, or equivalent to some of the technical features, and the modifications and substitutions do not depart from the spirit and scope of the technical solutions of the embodiments of the present disclosure.

What is claimed is:

1. A system for file storage, comprising:
a host; and
a storage device connected to the host,
wherein the host is configured to receive a file sent by an upload terminal and transfer the file to the storage device, the storage device comprises a format conversion module and a storage module, and the format conversion module is configured to convert an initial format of the file into a target format and the storage module is configured to store the file in the target format.

2. The system of claim 1, wherein the storage device is a solid state drive.

3. The system of claim 2, wherein the storage module comprises a storage controller and a plurality of storage units connected to the storage controller, and the storage controller is configured to control the reading and writing of the plurality of storage units.

4. The system of claim 3, wherein the storage device further comprises a processor in communication connection with the format conversion module and the storage controller, wherein the processor is configured to:
read and analyze an instruction signal received by the storage device;
determine whether the initial format of the file is consistent with the target format; and
when the initial format of the file is inconsistent with the target format, control the format conversion module to convert the initial format of the file into the target format.

5. The system of claim 4, wherein the storage device further comprises a bus interface, the bus interface is communicatively connected with the processor and the format conversion module, and the bus interface is connected to the host and configured to transmit the instruction signal.

6. A method for file storage, comprising:
receiving, by a host, a file sent by an upload terminal;
transmitting, by the host, the file to a storage device; and
converting an initial format of the file into a target format by a format conversion module in the storage device, wherein a storage module in the storage device is configured to store the file in the target format.

7. The method of claim 6, wherein the step of converting the initial format of the file into the target format by the format conversion module in the storage device further comprises the following steps:
determining by a processor in the storage device whether the initial format of the file is consistent with the target format; and
controlling the format conversion module by the processor to convert the initial format of the file into the target format when the initial format of the file is inconsistent with the target format.

8. The method of claim 7, wherein the step of converting the initial format of the file into the target format by the format conversion module in the storage device further comprises the following steps:
reading, by the processor, an upload instruction received by the storage device;
analyzing, by the processor, deadline setting information corresponding to the upload instruction;
sending, by the processor, a delete instruction to the storage controller in the storage module when a storage time of the file in the storage module reaches a access period set by a user,
receiving, by the storage controller, the delete instruction and deleting the files of a storage unit in the storage module.

9. The method of claim 8, after the step of the storage module in the storage device stores the file in the target format, further comprising the following steps:
receiving, by the host, access instruction sent by an access terminal and sending the access instruction to the storage device;
calling up, by the storage device according to the access instruction, a file in the target format matching the type of the access terminal from the storage module and sending the file in the target format to the host; and
sending, by the host, the target format file to the access terminal.

10. The method of claim 9, wherein the step of calling up, by the storage device according to the access instruction, the file in the target format matching the type of the access terminal from the storage module and sending the file in the target format to the host, further comprises the following steps:
converting, by the format conversion module, the format of the file requested to be accessed by the access terminal into the target format to match the type of the access terminal when the storage module does not store the file in the target format that matches the type of the access terminal, and then sending the target format file to the host.

11. The method of claim 10, wherein the file comprises a plurality of files, and wherein the step of sending, by the host, the target format file to the access terminal further comprises the following steps:
sending, by the host, a plurality of abbreviated files corresponding to a plurality of target format files to the access terminal;
displaying the plurality of abbreviated files sequentially by the access terminal;
receiving, by the access terminal, a click instruction from the user regarding a demanded abbreviated file;
transmitting, by the access terminal, the click instruction to the host;
sending, by the host, a demanded target format file corresponding to the demanded abbreviated file to the access terminal according to the click instruction; and
displaying the demanded target format file by the access terminal.

12. A device for file storage, comprising:
a format conversion module configured to convert an initial format of a file transferred from a host into a target format; and
a storage module configured to store the file in the target format.

13. The device of claim 12, wherein the device is a solid state drive.

14. The device of claim 13, wherein the storage module comprises a storage controller and a plurality of storage units connected to the storage controller, and the storage controller is configured to control the reading and writing of the plurality of storage units.

15. The device of claim 14, further comprising a processor in communication connection with the format conversion module and the storage controller, wherein the processor is configured to:
read and analyze an instruction signal received by the storage device;
determine whether the initial format of the file is consistent with the target format; and
when the initial format of the file is inconsistent with the target format, control the format conversion module to convert the initial format of the file into the target format.

16. The device of claim 15, further comprising a bus interface, wherein the bus interface is communicatively connected with the processor and the format conversion module, and the bus interface is connected to the host and configured to transmit the instruction signal.
